(19) United States
(12) Patent Application Publication
(10) Pub. No.: US 2022/0019890 A1
(43) Pub. Date: Jan. 20, 2022

(54) METHOD AND DEVICE FOR CREATING A MACHINE LEARNING SYSTEM

(71) Applicant: Robert Bosch GmbH, Stuttgart (DE)

(72) Inventors: Benedikt Sebastian Staffler, Tuebingen (DE); David Stoeckel, Rutesheim (DE)

(21) Appl. No.: 17/372,142

(22) Filed: Jul. 9, 2021

(30) Foreign Application Priority Data
Jul. 15, 2020 (DE) 102020208828.4

(51) Int. Cl. G06N 3/08; G06K 9/62

(52) U.S. Cl. CPC G06N 3/08; G06K 9/6228; G06K 9/6296; G06K 9/6298; G06K 9/6261

(57) ABSTRACT

A method for creating a machine learning system. The method includes: providing a directed graph including an input and an output node, each edge being assigned a probability that characterizes at which probability an edge is drawn. The probabilities are initially set to a value that paths are drawn at the same probability starting from the particular edge up to the output node.

### CROSS REFERENCE

The present application claims the benefit under 35 U.S.C. § 119 of German Patent Application No. DE 102020208828.4 filed on Jul. 15, 2020, which is expressly incorporated herein by reference in its entirety.

### FIELD

The present invention relates to a method for creating a machine learning system by using an architecture model, in particular a one-shot model, having initially identically probable paths, as well as a computer program and a machine-readable memory medium.

### BACKGROUND INFORMATION

The object of architecture search for neural networks is to fully automatically find a good network architecture in the sense of a performance indicator/metric for a predefined data set.

In order to design the automatic architecture search to be calculation-efficient, different architectures may share the weights of their operations in the search space, such as for example in the case of a one-shot NAS model, described by Pham, H., Guan, M. Y., Zoph, B., Le, Q. V., & Dean, J. (2018), “Efficient neural architecture search via parameter sharing,” arXiv preprint arXiv:1802.03268.

The one-shot model is typically constructed as a directed graph, in the case of which nodes represent data and edges represent operations that illustrate a calculation rule and transfer the input node of the edge to the output node. The search space includes subgraphs (for example paths) in the one-shot model. Since the one-shot model may be very large, it is possible to draw (i.e., sample or select) individual architectures from the one-shot model for the training, such as for example described by Cai, H., Zhu, L., & Han, S. (2018), “Proxylessnas: Direct neural architecture search on target task and hardware,” arXiv preprint arXiv:1812.00332. This typically takes place in that a single path is drawn from an established input node to an output node of the network, such as for example described by Guo, Z., Zhang, X., Mu, H., Heng, W., Liu, Z., Wei, Y., & Sun, J. (2019), “Single path one-shot neural architecture search with uniform sampling,” arXiv preprint arXiv:1904.00420.

Here, a probability distribution is typically defined via the outgoing edges of a node and initialized at the same probabilities for all edges, such as for example described by Guo at al. (2019).

### SUMMARY

As described above, paths are drawn (i.e., sampled or selected), from a one-shot model between input and output nodes. For this purpose, a probability distribution is defined for each node via the outgoing edges. The inventors provide that the probabilities of the outgoing edges are not selected to be the same for each edge, but in such a way that every possible path has the same probability as a result of the one-shot model. It may thus may be said that the probability distributions of the edges are initialized in such a way that all paths from the input node to the output node have the same probability of being drawn.

The present invention allows for paths to be drawn from a one-shot model without implicit preference for individual paths. In this way, all architectures of the search space are initially drawn equally frequently and the search space is explored in an unbiased manner. This has the advantage that more superior architectures may ultimately be found that would not have been found in the case of a conventional initialization of the edges.

In a first aspect, the present invention relates to a computer-implemented method for creating a machine learning system that may preferably be used for image processing.

In accordance with an example embodiment of the present invention, the method includes at least the following steps:

Providing a directed graph including an input and an output node that are connected via a plurality of edges and nodes. Each edge is assigned a probability that characterizes at which probability the edge is drawn from all outgoing edges of a node. The probabilities are initially set to a value, so that each path is drawn at the same probability starting from the input node to the output node. Subsequently, a plurality of paths is randomly drawn through the graph, and the machine learning systems corresponding to the paths are trained. During training, parameters of the machine learning system and the probabilities of the edges of the path are adjusted, so that a cost function is optimized.

Subsequently, a path is drawn as a function of the adjusted probabilities. The path having the highest probability is preferably selected. The probability of a path results from the product of the probability of all its edges. The machine learning system that is corresponding to and associated with this path is then created.

Alternatively, the path may be drawn randomly in the last step, in particular after the optimization of the cost function has been completed, or the edges having the highest probabilities may be followed up to the output node in a targeted manner to obtain the path.

It is furthermore provided that in the process of drawing the path, the path is iteratively created, the subsequent edge being randomly selected at each node from the potential subsequent edges, which are connected to this node, as a function of their assigned probability.

The machine learning system is preferably an artificial neural network that may be configured for segmentation and object detection in images.

In a further aspect of the present invention, it is provided that the machine learning system is trained to ascertain an output variable, which is then used to ascertain a control variable with the aid of a control unit, as a function of a detected sensor variable of a sensor. Here, the machine learning system may have been trained to detect objects, and it is then possible to ascertain the control variable with the aid of the machine learning system as a function of a detected object.

The control variable may be used to control an actuator of a technical system. The technical system may be an at least semi-autonomous machine, an at least semi-autonomous vehicle, a robot, a tool, heavy equipment, or a flying object, such as a drone. The input variable may be, for example, ascertained as a function of the detected sensor data and provided to the machine learning system. The sensor data may be detected or alternatively externally received by a sensor, such as a camera of the technical system, for example.

In further aspects, the present invention relates to a computer program, which is configured to carry out the above-described methods, and a machine-readable memory medium, on which this computer program is stored.

Specific embodiments of the present invention are explained below in greater detail with reference to the figures.

### BRIEF DESCRIPTION OF THE DRAWINGS

FIG. 1 schematically shows a directed acyclic multigraph including standard initialization.

FIG. 2 shows a schematic illustration of a flow chart for the initialization of edges.

FIG. 3 shows a schematic illustration of an actuator control system.

FIG. 4 shows one exemplary embodiment for controlling an at least semi-autonomous robot.

FIG. 5 schematically shows one exemplary embodiment for controlling a manufacturing system.

FIG. 6 schematically shows one exemplary embodiment for controlling an access system.

FIG. 7 schematically shows one exemplary embodiment for controlling a monitoring system.

FIG. 8 schematically shows one exemplary embodiment for controlling a personal assistant.

FIG. 9 schematically shows one exemplary embodiment for controlling a medical imaging system.

FIG. 10 shows a possible configuration of a training device.

### DETAILED DESCRIPTION OF EXAMPLE EMBODIMENTS

In order to find good architectures of deep neural networks for a predefined data set, automatic methods for architecture search, so-called neural architecture search methods, may be applied. For this purpose, a search space of possible architectures of neural networks is defined explicitly or implicitly.

In the following, the term operation describes a calculation rule that transfers one or multiple n-dimensional input data tensors to one or multiple output data tensors and that may have adaptable parameters for the purpose of describing a search space. During image processing, for example, convolutions having different kernel sizes and different types of convolution (regular convolution, depthwise separable convolution) and pooling operations are often used as operations.

Furthermore, a calculation graph (the so-called one-shot model), is to be defined in the following, which includes all architectures in the search space as subgraphs. Since the one-shot model may be very large, it is possible to draw (i.e., sample or select) individual architectures from the one-shot model for the training. This typically takes place in that the individual paths are drawn from an established input node to an established output node of the network.

In the simplest case, if the calculation graph includes a chain of nodes, which may be connected via different operations in each case, it is sufficient to draw the operation connecting two consecutive nodes in each case.

If the one-shot model is a directed graph in general, a path may be drawn iteratively, in the case of which the process is started at the input, then the next node and the connecting operation are drawn, and this is then continued iteratively up to the target node.

The one-shot model may then be trained via drawing in that for each mini batch an architecture is drawn and the weights of the operations are adjusted in the drawn architecture with the aid of a standard gradient step method. Finding the best architecture may take place either as a separate step following the training of the weights or be carried out alternatingly with the training of the weights.

For the automatic architecture search, a directed acyclic multigraph having nodes nᵢ and edges n_{i,j}^{k} is to be contemplated from nᵢ to nⱼ, k describing the multiplicity of the edges. The graph additionally includes an input node n₀ and an output node n_{L} and a topology, so that all paths starting at the input node lead to the output node. Starting from output node n_{L} it is now possible to iteratively determine for each node the number of paths N to the output node:

$$N ( {n}_{L} ) = 0 \\ N ( {n}_{i} ) = {\sum }_{j , k} N ( {n}_{j} ) \# \{ {n}_{( i , j )}^{k} \} \qquad ( Equation 1 )$$

where #{n_{(i,j)}^{k}} is the number of the edges between nodes nᵢ and nⱼ. In particular, N(n₀) is the total number of the paths in the graph.

Now, if the probability is established for each edge:

p(n_{i,j}^{k})=N(nⱼ)/N(nᵢ), (Equation 2):

so it applies to all outgoing paths of a node

$${\sum }_{j , k} p ( {n}_{i , j}^{k} ) = \frac{1}{N ( {n}_{i} )} {\sum }_{j , k} N ( {n}_{j} ) = \frac{1}{N ( {n}_{i} )} {\sum }_{j} N ( {n}_{j} ) \# \{ {n}_{i , j}^{k} \} = 1 \qquad ( Equation 3 )$$

i.e., p(n_{i,j}^{k}) defines a probability distribution across the outgoing edges of nᵢ. Moreover, for the probability of a path g that includes edges n_{i,j}^{k} it is calculated from the product of the probabilities of all edges in the path:

$$P ( g ) = {\prod }_{{n}_{i , j}^{k} ∈ g} p ( {n}_{i , j}^{k} ) = \frac{N ( {n}_{L} )}{N ( {n}_{0} )} = \frac{1}{N ( {n}_{0} )} \qquad ( Equation 4 )$$

i.e., all paths have the same probability.

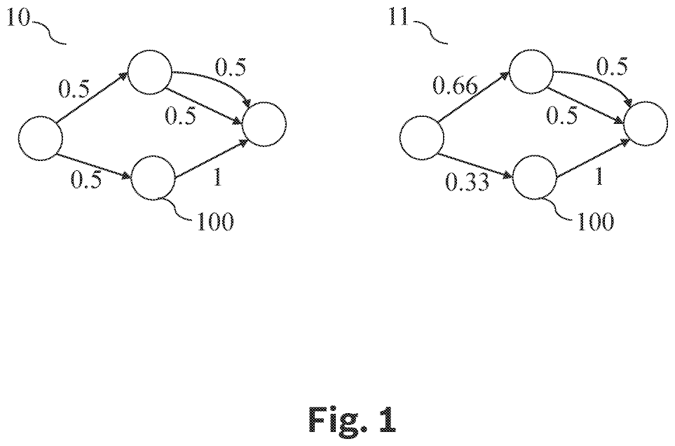

This is schematically illustrated in FIG. 1. FIG. 1 shows a first directed acyclic multigraph 10 including a minimal number of nodes 100 having the standard initialization. This means that all outgoing edges of a node have the same probability of 0.5 or 1. In this case, the path leading downward from the input has a higher probability of 0.5 than the two paths leading from the input to the upper node, each having a probability of 0.25. Second directed acyclic multigraph 11 having a minimal number of nodes 100 has the initialization provided above, which ensures that all paths have the same probability.

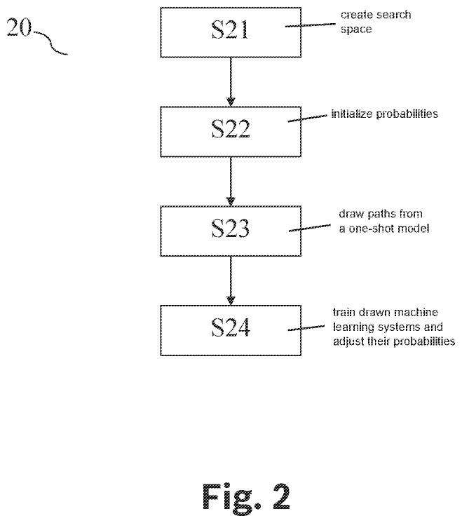

FIG. 2 schematically shows a flowchart 20 of the method for the initialization of the edges of a directed acyclic multigraph and for the architecture search using this multigraph.

The automatic architecture search may then be carried out as follows. The automatic architecture search initially requires the creation of a search space (S21), which may be provided in this case in the form of a one-shot model. The one-shot model is in this case a multigraph as described above. Prior to the training, the probabilities, such as the ones described in (equation 3), are initialized (S22). In this way, all paths in the one-shot model have the same probability of being drawn.

Subsequently, every form of the architecture search may be used, which paths are drawn (S23) from a one-shot model.

In subsequent step S24, the drawn machine learning systems corresponding to the paths are trained and their probabilities are also adjusted as a function of the training.

It is to be noted that optimization may not only take place with regard to accuracy, but also for special hardware (for example hardware accelerator). For example, in that during training the cost function includes a further term that characterizes the costs for carrying out the machine learning system using its configuration on the hardware.

Steps S23 and S24 may be repeated several times, one after another. Subsequently, a final path may be drawn based on the multigraph and a corresponding machine learning system may be initialized according to this path.

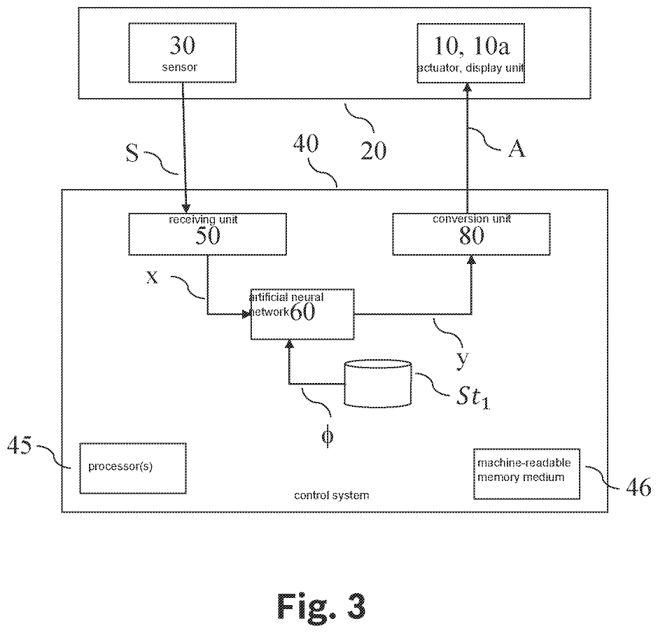

The machine learning system is preferably an artificial neural network 60 (illustrated in FIG. 3) and is used as elucidated in the following.

FIG. 3 shows an actuator 10 in its surroundings 20 interacting with a control system 40. Surroundings 20 are detected at preferably regular time intervals in a sensor 30, in particular in an imaging sensor such as a video sensor, which may also be provided by a plurality of sensors, for example a stereo camera. Other imaging sensors are also possible, such as radar, ultrasonic or LIDAR sensors, for example. An infrared camera is also possible. Sensor signal S—or in the case of multiple sensors, each sensor signal S—of sensor 30 is transmitted to control system 40. Control system 40 thus receives a sequence of sensor signals S. Control system 40 ascertains from it activating signals A that are transferred to actuator 10.

Control system 40 receives the sequence of sensor signals S of sensor 30 in an optional receiving unit 50 that converts the sequence of sensor signals S into a sequence of input images x (alternatively, each sensor signal S may also be directly applied as input image x). Input image x may be a detail or a further processing of sensor signal S, for example. Input image x includes individual frames of a video recording. In other words, input image x is ascertained as a function of sensor signal S. The sequence of input images x is supplied to a machine learning system, an artificial neural network 60 in the exemplary embodiment.

Artificial neural network 60 is preferably parametrized by parameters ϕ that are stored in a parameter memory P and provided by same.

Artificial neural network 60 ascertains output variables y from input images x. These output variables y may in particular include a classification and semantic segmentation of input images x. Output variables y are supplied to an optional conversion unit 80 that ascertains from it activating signals A that are supplied to actuator 10 to correspondingly activate actuator 10. Output variable y includes information about objects detected by sensor 30.

Monitoring signal d characterizes, whether or not neural network 60 reliably ascertains output variables y. If monitoring signal d characterizes that the ascertainment is not reliable, it may be provided, for example, that activating signal A is ascertained according to a secured operating mode (while otherwise it is ascertained in a normal operating mode). The secured operating mode may for example include that a dynamic of actuator 10 is reduced or that the functions for activating actuator 10 are switched off.

Actuator 10 receives activating signals A, is activated accordingly and carries out a corresponding action. In this case, actuator 10 may include an activation logic (which is not necessarily structurally integrated) that ascertains from activating signal A a second activating signal, using which actuator 10 is then activated.

In a further specific embodiment, control system 40 includes sensor 30. In yet a further specific embodiment, control system 40 alternatively or additionally also includes actuator 10.

In further preferred specific embodiments, control system 40 includes one or a plurality of processors 45 and at least one machine-readable memory medium 46, on which instructions are stored that prompt control system 40 to carry out the method according to the present invention, if they are carried out on processors 45.

In alternative specific embodiments, a display unit 10a is provided alternatively or additionally to actuator 10.

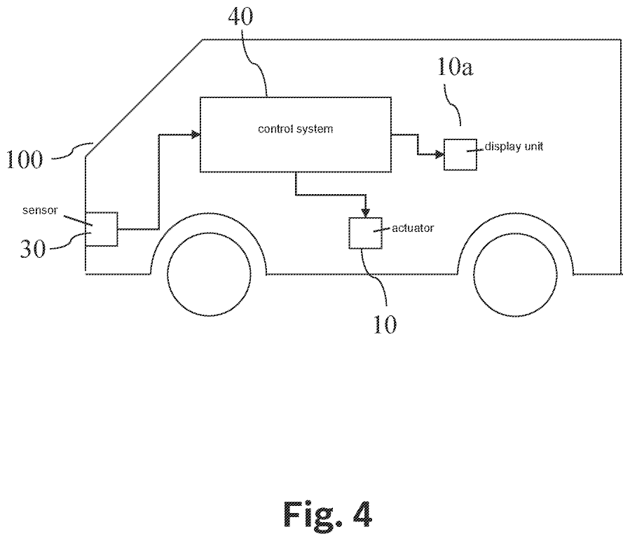

FIG. 4 shows, how control system 40 may be used to control an at least semi-autonomous robot, an at least semi-autonomous motor vehicle 100 in the present case.

Sensor 30 may be a video sensor, for example, which is preferably situated in motor vehicle 100.

Artificial neural network 60 is configured to reliably identify objects from input images x.

Actuator 10, preferably situated in motor vehicle 100, may be a brake, a drive, or a steering of motor vehicle 100, for example. Activating signal A may then be ascertained in such a way that actuator(s) 10 is/are activated in such a way that motor vehicle 100 prevents a collision with the object, for example, which was reliably identified by artificial neural network 60, in particular if objects of particular categories, for example pedestrians, are involved.

The at least semi-autonomous robot may alternatively also be another mobile robot (not illustrated), for example the type that moves by flying, swimming, diving or stepping. The mobile robot may also be an at least semi-autonomous lawn mower, for example, or an at least semi-autonomous cleaning robot. In these cases, activating signal A may also be ascertained in such a way that the drive and/or steering of the mobile robot is/are activated in such a way that the at least semi-autonomous robot prevents a collision with the objects, which were identified by artificial neural network 60.

Alternatively or additionally, display unit 10a may be activated by activating signal A, and the ascertained safe areas may be displayed, for example. For example, it is also possible in the case of a motor vehicle 100 without automated steering that display unit 10a is activated using activating signal A in such a way that it outputs a visual or an acoustic warning signal if it is ascertained that motor vehicle 100 risks collision with one of the reliably identified objects.

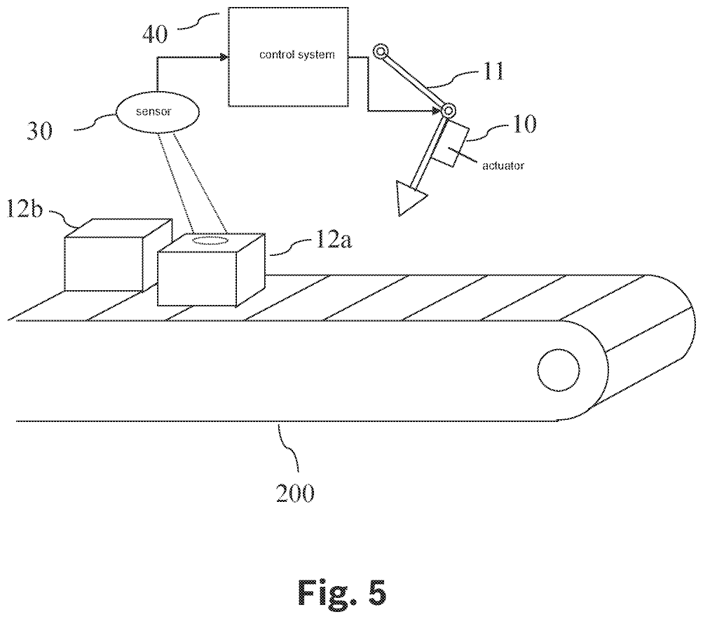

FIG. 5 shows one exemplary embodiment, in which control system 40 is used to activate a manufacturing machine 11 of a manufacturing system 200, in that an actuator 10 controlling this manufacturing machine 11 is activated. Manufacturing machine 11 may be a machine for punching, sawing, drilling and/or cutting, for example.

Sensor 30 may in this case be an optical sensor, for example, which detects properties of manufactured goods 12a, 12b, for example. It is possible that these manufactured goods 12a, 12b are movable. It is possible that actuator 10 controlling manufacturing machine 11 is activated as a function of an assignment of detected manufactured goods 12a, 12b, so that manufacturing machine 11 correspondingly carries out a subsequent processing step of correct manufactured good 12a, 12b. It is possible that by identifying the correct properties of the same manufactured goods 12a, 12b (i.e., without a misclassification), manufacturing machine 11 correspondingly adjusts the same manufacturing step for processing a subsequent manufactured good.

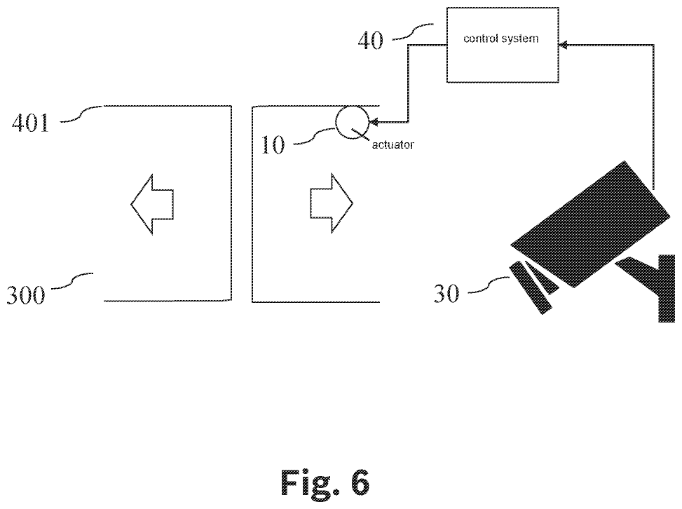

FIG. 6 shows one exemplary embodiment, in which control system 40 is used to control an access system 300. Access system 300 may include a physical access control, for example a door 401. Video sensor 30 is configured to detect a person. This detected image may be interpreted with the aid of object identification system 60. If several persons are detected at the same time, it is possible to particularly reliably ascertain the identity of the persons by assigning the persons (i.e., the objects) to one another, for example, by analyzing their movements, for example. Actuator 10 may be a lock that allows or does not allow access control, for example opens or does not open door 401, as a function of activating signal A. For this purpose, activating signal A may be selected as a function of the interpretation by object identification system 60, for example as a function of the ascertained identity of the person. A logic access control may also be provided instead of the physical access control.

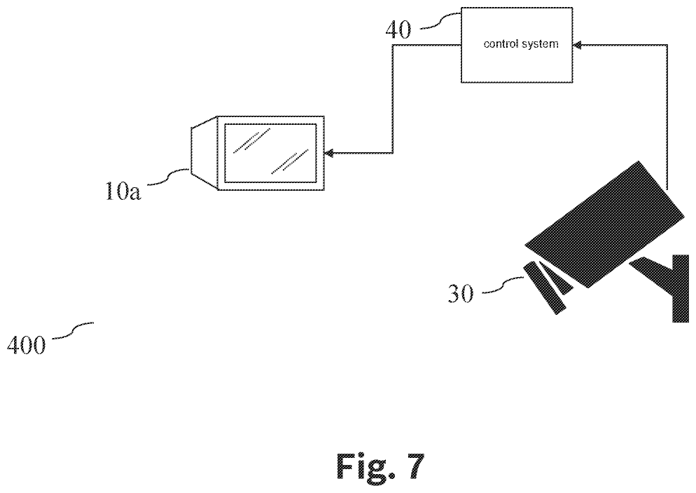

FIG. 7 shows one exemplary embodiment, in which control system 40 is used to control a monitoring system 400. This exemplary embodiment differs from the exemplary embodiment illustrated in FIG. 5 in that display unit 10a, which is activated by control system 40, is provided instead of actuator 10. For example, an identity of the objects recorded by video sensor 30 may be reliably ascertained by artificial neural network 60 in order to for example deduce as a function thereof, which ones seem conspicuous, and activating signal A is then selected in such a way that this object is highlighted by display unit 10a with the aid of colors.

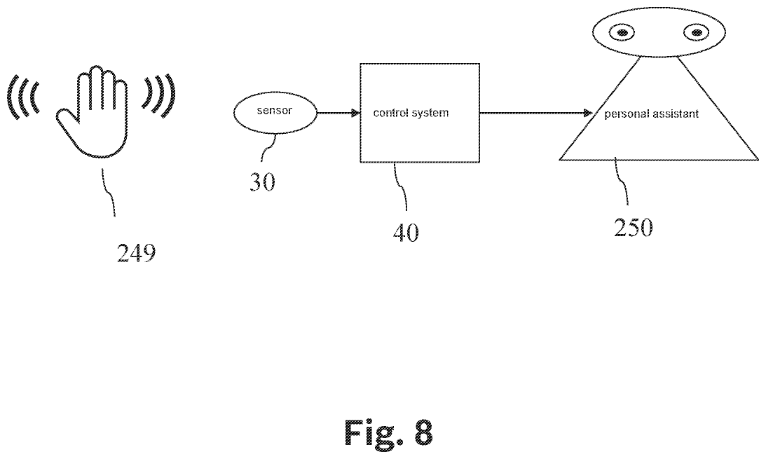

FIG. 8 shows one exemplary embodiment, in which control system 40 is used to control a personal assistant 250. Sensor 30 is preferably an optical sensor that receives images of a gesture of a user 249.

Control system 40 ascertains an activating signal A of personal assistant 250, for example in that the neural network carries out a gesture recognition, as a function of the signals of sensor 30. Personal assistant 250 is then fed this ascertained activating signal A and is thus accordingly activated. This ascertained activating signal A may be selected in particular in such a way that it corresponds to an assumed desired activation by user 249. This assumed desired activation may be ascertained as a function of the gesture recognized by artificial neural network 60. Control system 40 may then select activating signal A for transfer to personal assistant 250 as a function of the assumed desired activation and/or select activating signal A for transfer to the personal assistant 250 according to assumed desired activation.

This corresponding activation may for example include that personal assistant 250 retrieves information from a database and forwards it to user 249 in a receivable manner.

Instead of personal assistant 250, a household appliance (not illustrated), in particular a washing machine, a stove, an oven, a microwave or a dishwasher, may also be provided to be correspondingly activated.

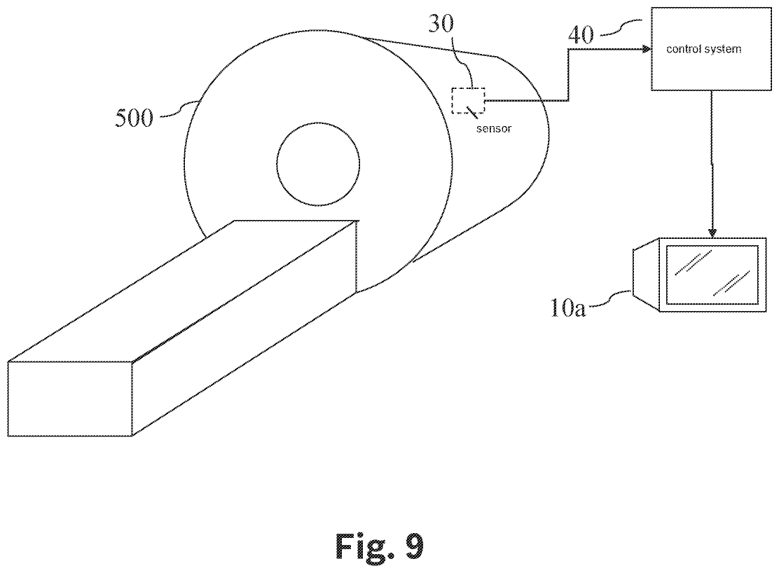

FIG. 9 shows one exemplary embodiment, in which control system 40 is used to control a medical imaging system 500, for example an MRI, an X-ray or an ultrasonic device. Sensor 30 may be an imaging sensor, for example; display unit 10a is activated by control system 40. For example, neural network 60 may ascertain whether an area recorded by the imaging sensor is conspicuous, and activating signal A may then be selected in such a way that this area is highlighted by display unit 10a with the aid of colors.

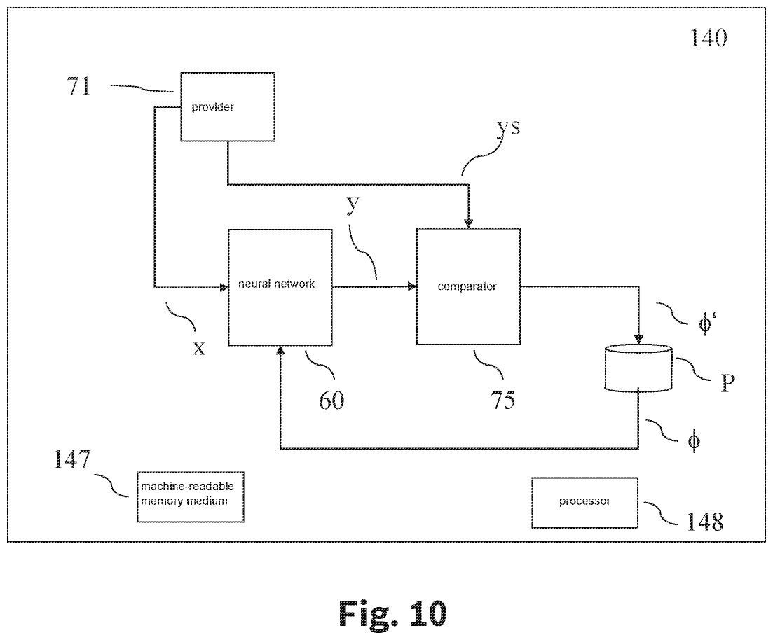

FIG. 10 shows, by way of example, a second training device 140 for training a machine learning system drawn from the multigraph training of neural network 60. Training device 140 includes a provider 71 that provides input images x and setpoint output variables ys, for example setpoint classifications. Input image x is supplied to artificial network 60 that is to be trained and that uses it to ascertain output variables y. Output variables y and setpoint output variables ys are supplied to a comparator 75 that uses these to ascertain as a function of an agreement new parameters ϕ′ for particular output variables y and setpoint output variables ys, which are transferred to parameter memory P and replace parameters ϕ.

The methods carried out by training system 140 may be implemented as a computer program and stored on a machine-readable memory medium 147 and carried out by a processor 148.

Naturally, there is no need to classify entire images. It is possible that image sections are classified as objects with the aid of a detection algorithm, for example, that these image sections are then cut out, a new image section is potentially generated, and inserted into the associated image in place of the cut-out image section.

The term “computer” includes any arbitrary devices for handling predefinable calculation rules. These calculation rules may be in the form of software or in the form of hardware or also in a mix of software and hardware.

What is claimed is:

1. A computer-implemented method for creating a machine learning system, the method comprising the following steps:
providing a directed graph having an input node and an output node that are connected via a plurality of edges and nodes, each edge of the edges being assigned a probability that characterizes at which probability the edge is drawn, the probabilities being initially set to a value that paths are drawn at the same probability starting from the edge up to the output node;
randomly drawing a plurality of paths through the graph and training the machine learning systems corresponding to the paths; and
adjusting parameters of the machine learning system and the probabilities of the edges of the path during training, so that a cost function is optimized; and
drawing a path as a function of the adjusted probabilities and creating the machine learning system corresponding to the drawn path.

2. The method as recited in claim 1, wherein starting from a selected node, all possible paths to the output node are counted, a value of the probability of each edge of those edges that are connected proceeding from the selected node is initially set to a number of the possible paths running via the edge, divided by a number of the counted possible paths.

3. The method as recited in claim 1, wherein all possible paths up to the output node are counted for each node of the directed graph, a value of the probability of each edge of the edges is initially set to a number of the possible paths from the output node of the edge divided by a number of the possible paths of an input node of the edge.

4. The method as recited in claim 1, wherein in the process of drawing the path, the path is iteratively created, the subsequent edge being randomly selected at each node from the possible subsequent edges, which are connected to the node, as a function of its assigned probability.

5. A non-transitory machine-readable memory medium on which is stored a computer program for creating a machine learning system, the method comprising the following steps:
providing a directed graph having an input node and an output node that are connected via a plurality of edges and nodes, each edge of the edges being assigned a probability that characterizes at which probability the edge is drawn, the probabilities being initially set to a value that paths are drawn at the same probability starting from the edge up to the output node;
randomly drawing a plurality of paths through the graph and training the machine learning systems corresponding to the paths; and
adjusting parameters of the machine learning system and the probabilities of the edges of the path during training, so that a cost function is optimized; and
drawing a path as a function of the adjusted probabilities and creating the machine learning system corresponding to the drawn path.

6. A device configured to create a machine learning system, the device configured to:
provide a directed graph having an input node and an output node that are connected via a plurality of edges and nodes, each edge of the edges being assigned a probability that characterizes at which probability the edge is drawn, the probabilities being initially set to a value that paths are drawn at the same probability starting from the edge up to the output node;
randomly draw a plurality of paths through the graph and training the machine learning systems corresponding to the paths; and
adjust parameters of the machine learning system and the probabilities of the edges of the path during training, so that a cost function is optimized; and
draw a path as a function of the adjusted probabilities and create the machine learning system corresponding to the drawn path.
